(19) United States
(12) Patent Application Publication
(10) Pub. No.: US 2006/0101736 A1
(43) Pub. Date: May 18, 2006

(54) Door structure for avoiding from confinement and door altering member therefore

(75) Inventor: Yoshiaki Okugawa, Yokosuka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SUN HOUSING CORPORATION, Yokosuka-shi (JP)

(21) Appl. No.: 11/259,098

(22) Filed: Oct. 27, 2005

(30) Foreign Application Priority Data
Oct. 28, 2004 (JP) 313191/2004

(51) Int. Cl. E06B 1/04

(52) U.S. Cl. 52/204.1

(57) ABSTRACT

To provide a door structure capable of avoiding from resident confinement in the event of a big earthquake.

An upper wall 3 which inclines upward from a horizontal direction in a door-opening direction X is provided on an upper portion of a door body 1. Correspondingly, an inclined plane 12 is provided on a door head 11. Further, a rotary member such as a roller which is in touch with a door sill is provided at a lower wall of door body 1. With this structure, if a door frame 10 is distorted by an earthquake, door frame 10 pushes upper wall 3 of door body 1, resulting in a force exerting to door body 1 in a door-opening direction. The rotary member provided to the lower wall facilitates a door-opening action.

### BACKGROUND OF THE INVENTION

The present invention relates to a door structure for avoiding a resident from being confined in a room when an earthquake happens, and, specifically, to a door structure and door altering member suitable for using for such a building structure as condominium.

Steel doors are widely used for entrance doors of building structures including high-rise apartment buildings. In such a steel door, a door body as well as a door frame and a door hinge may be distorted by distortion and destruction due to an earthquake. As a result, the door cannot be opened nor closed, and, thus, residents are confined in a room and cannot be rescued. Such an accident has really happened.

In order to solve such a problem, Japanese Patent Laid-open Nos. Hei 8-333936 and Hei 9-317340 have proposed a technology to thereby enable a door to be easily opened and closed even when a wall of a building structure has been distorted by an earthquake. For example, it has been proposed to form tapered planes and flat planes on both an outer surface of a door and an inner surface of a door frame so that those tapered planes and the flat planes oppose each other, to thereby exert a force in a direction to open the door due to mutual action of the tapered planes and the flat planes, even if a wall is destroyed and frames are distorted due to an earthquake. As a result, a door body can be opened automatically if the door is not locked because distortion of a wall of a building structure causes a force to exert on a door body in a direction to open the door. Even if the door is locked, the door body can be opened by unlocking the door. Consequently, it is said that such a technology may lower the danger that residents are confined in a room.

However, in the prior art described above, a portion of an outer surface of the door tapers in cross section to reduce the height toward the room and the remaining portion of the outer surface is formed to be a flat plane. In addition, a tapered plane and a flat plane are formed on an inner surface of a door frame to correspond to the tapered plane and the flat plane of the outer surface of the door. In other words, in the prior art, the flat planes are formed on both opposing surfaces of the door and the door frame. Consequently, such a problem may occur that depending on how extent walls are destroyed and hinges are distorted by an earthquake, the flat plane formed on the door may be clamped tightly in horizontal and vertical directions by the flat plane formed on the door frame and there is an possibility that the door may not be opened.

Further, it is only possible to apply the formation of tapered planes and flat planes on a door and a door frame to newly-constructed building structures. If the formation of tapered and flat planes on a door and a door frame is applied to an existing building structure, such expensive and time-consuming works as door alteration or replacement and a work on a door frame are required. This means that it is impossible in practice to apply the formation to an existing building structure. Nevertheless, it is an urgent need to enhance an earthquake-proof ability of existing building structures and to secure any means for avoiding residents from being confined in rooms when a big earthquake happens. There is a need for simple and low-cost means for reliably enabling residents to get out of rooms even if a big earthquake happens.

### SUMMARY OF THE INVENTION

The present invention has been proposed in view of the various problems described above. One of the objects of the present invention is to provide a door structure having a simple structure for avoiding a resident from being confined in a room in the event of an earthquake. Another of the objects of the present invention is to provide a door altering member for avoiding a resident from being confined in a room in the event of an earthquake and applicable to a door structure of an existing building structure simply at a low cost.

To achieve the objects above, the invention of claim 1 provides a door structure having a door frame and a door body rotatably mounted to said door frame and capable of being installed to a building structure, comprising a mechanism for exerting a force to said door body in a door-opening direction due to a distortion of said door frame.

The invention of claim 2 provides a door structure according to claim 1, wherein said door body comprises an inner surface, an outer surface, and an upper wall formed as an inclined flat plane that inclines linearly from the inner surface to the outer surface in the door-opening direction upward from a horizontal direction; wherein said door frame comprises a head and a sill, the head opposing to said upper wall of said door body; wherein said head has an inclined plane which is parallel to said upper wall when said door body is closed; and wherein said mechanism comprises said upper wall and said inclined plane.

The invention of claim 3 provides a door structure according to claim 2, wherein said door body further comprises a rotary member which is mounted to an appropriate position to a lower wall opposing to said upper wall and which is in touch with said door sill.

The invention of claim 4 provides a door structure according to claim 3, wherein said sill has a plane which inclines downward from a horizontal direction in the door-opening direction.

The invention of claim 5 provides a door body having an inner surface, an outer surface and an upper wall and capable of being rotatably mounted to a door frame, said upper wall having a flat plane inclined linearly from said inner surface to said outer surface upward from a horizontal direction in a door-opening direction.

The invention of claim 6 provides a door body according to claim 5, further comprising a rotary member mounted at an appropriate position to a lower wall opposing to said upper wall and which is in touch with a sill of said door frame.

The invention of claim 7 provides a door frame to which a door body can rotatably be mounted, comprising a head and a sill, said head having an inclined plane inclining upward from a horizontal direction of said door body in a door-opening direction.

The invention of claim 8 provides a head mounted member mounted to a head of a door frame to which a door body is rotatably mounted, comprising:

first and second mounting pieces fixed to said head; and

an intermediate piece interconnecting those mounting pieces, wherein said intermediate piece has a plane inclining upward from a horizontal direction in a door-opening direction when said intermediate piece is fixed to the head.

The invention of claim 9 provides a door mounted member mounted to a door body capable of being rotatably mounted to a door frame, comprising:

first and second mounting pieces fixed to the door body; and

an intermediate piece interconnecting those mounting pieces, wherein said intermediate piece has a plane inclining upward from a horizontal direction in a door-opening direction when said intermediate piece is fixed to the door body.

The invention of claim 10 provides a door structure altering member set comprising a head mounted member as claimed in claim 8 and a door mounted member as claimed in claim 9.

The invention of claim 11 provides a door structure altering member set according to claim 10, further comprising a slope member placed on a sill of the door frame.

The invention of claim 12 provides a method of altering a door structure including a door frame and a door body rotatably mounted to the door frame into a structure capable of exerting a force to the door body in a door-opening direction due to distortion of the door frame, said method comprising the steps of:

mounting a head mounted member as claimed in claim 8 to a head of the door frame;

fabricating an upper portion of the door body to form a plane inclining with respect to a horizontal direction; and

mounting a door mounted member as claimed in claim 9 to the upper portion of the door body.

According to the present invention, an upper wall of a door body is formed to be inclined, a door upper frame is provided with an inclined plane corresponding to the inclined upper wall of the door body and a rotary member is provided at an appropriate position to a lower portion of the door body. Consequently, when a door frame is distorted by a big pressure or energy, the inclined plane of the door head pushes the inclined upper wall of the door body to a door-opening direction. As a result, a resident can open the door body by rotating a knob and by assistance by the rotary member mounted to the lower portion of the door body to thereby avoiding a resident from being confined within a room when an earthquake occurs.

In addition, the upper wall of a door body is formed to a shape inclined linearly from an inner surface of the door body to an outer surface thereof in a door-opening direction. Correspondingly, a door head is provided with a plane that uniformly comes into contact with the upper wall of the door body. Consequently, even if a door frame is distorted, the distortion exerts a force such that pushes the upper wall of the door body in a door-opening direction. As a result, it is easy to open the door body and such a danger that the door body is clamped by the door frame and cannot be opened is eliminated.

A door altering member according to the present invention can be manufactured at low cost with a simple structure so as to comply with the structure of a door frame and a door body and can be easily mounted to a door body and a door frame of an existing building structure. Consequently, an existing building structure can easily be converted at low cost to such a structure that enables a resident to get out of a room.

### BRIEF DESCRIPTION OF THE DRAWINGS

FIG. 1 shows a front elevation view of an embodiment of a door structure according to the present invention;

FIG. 2 shows a cross sectional view of major components of an upper portion in a cross section along a line A-A shown in FIG. 1;

FIG. 3 shows a cross sectional view of major components of a lower portion in a cross section along a line A-A shown in FIG. 1;

FIG. 4 shows a front elevation view of major components of the lower portion shown in FIG. 3;

FIG. 5 shows a cross sectional view of another example of major components of the lower portion shown in FIG. 3;

FIG. 6 shows a front elevation view of the example shown in FIG. 5;

FIG. 7 shows a front elevation view of an example of an existing door structure;

FIG. 8A shows a cross sectional view of a head mounted member according to the present invention;

FIG. 8B shows a cross sectional view of a door mounted member according to the present invention;

FIG. 9A is a cross sectional view showing a worked upper portion of an existing door body;

FIG. 9B is a cross sectional view showing a worked door body to which a door mounted member shown in FIG. 8B is mounted;

FIG. 9C is a cross sectional view showing a door head to which a head mounted member shown in FIG. 8A is mounted;

FIG. 10A is a cross sectional view showing an existing door structure to which a head mounted member and a door mounted member are mounted;

FIG. 10B is a cross sectional view showing a head mounted member to which sealing means is provided;

FIG. 11 is a front elevation view showing an existing door structure to which a head mounted member and a door mounted member are mounted;

FIG. 12A is a cross sectional view of a slope member placed on a horizontal sill; and

FIG. 12B is a perspective view of the slope member.

### THE BEST MODE FOR CARRYING OUT THE INVENTION

Detailed description will hereafter be made about embodiments regarding a door structure and a door altering member according to the present invention in conjunction with the attached drawings. It is noted that similar or equivalent components are designated by the same reference numerals throughout the drawings.

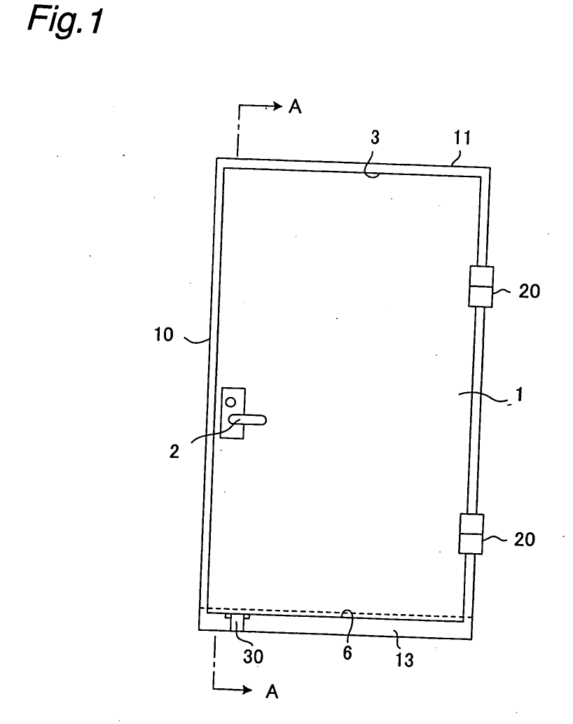

An embodiments of a door structure according to the present invention will first be described in detail with reference to FIGS. 1 to 6. In FIGS. 1 to 4, a door body 4 is axially supported by a door frame 10 of a building structure to be able to open and close via hinges 20, wherein door body 1 and door frame 10 form a door structure. It is noted that door body 1 can be opened in a direction to the outside, that is, in a door-opening direction designated by X, by rotating a door knob 2.

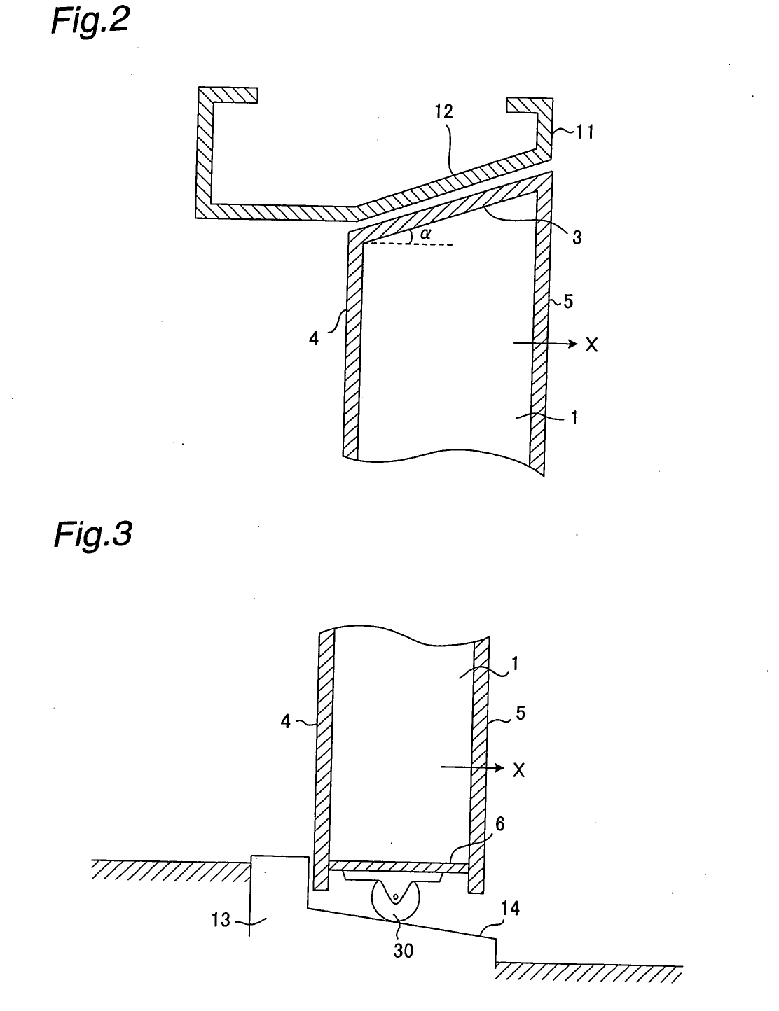

FIG. 2 shows an upper portion of the door structure in a cross section along a line A-A. As shown in FIG. 2, inclined planes parallel with each other are formed on opposing surfaces of door body 1 and a door head 11. Specifically, an upper wall 3 of door body 1 forms an inclined plane that interconnects an inner surface 4 and an outer surface 5 at a predetermined angle a upward from a horizontal direction so that outer surface 5 is longer than inner surface 4. In response, door head 11 which opposes upper wall 3 of door body 1 is configured to a shape having an inclined plane 12 that is substantially parallel to inclined upper wall 3 when door body 1 is closed.

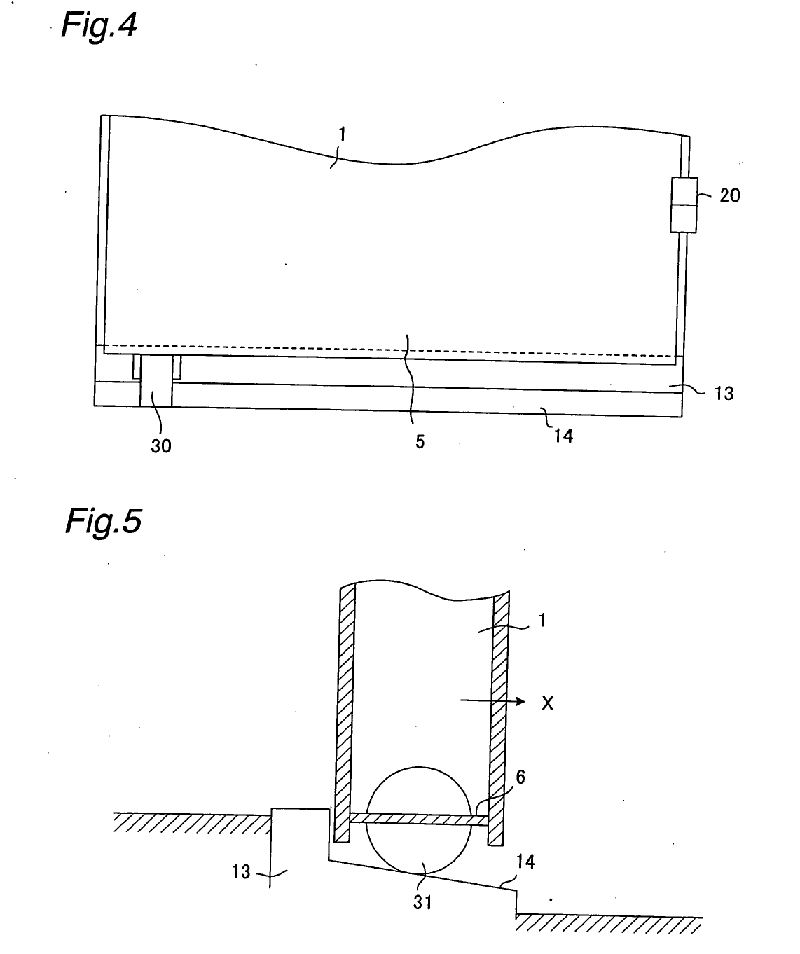

FIG. 3 shows a lower portion of the door structure in a cross section along line A-A. Usually, an inclined plane 14 that becomes lower from the inside of a room toward the outside is provided on a door sill 13. Thus, as shown in FIG. 3, a rotary member such as a roller 30 that can run on inclined plane 14 is mounted to a lower wall 6 of door body 1 in order to enable door body 1 to be opened and closed easily. It is noted, as shown in FIG. 4, that roller 30 is preferably mounted to a position nearer to a side wall to which knob 2 is mounted than a side wall to which hinges 20 are mounted. However, the embodiment is not limited to such a structure, and rollers 30 can be mounted to appropriate two positions along a lower side 5 of door body 1, for example.

Because a door structure according to the present invention is structured such as described above, inclined plane 12 formed on door frame 10 exerts a force to door upper wall 3 to push door body 1 in a door-opening direction. In other words, inclined plane 12 applies a force to door body 1 in door-opening direction X. In addition, because roller 30 is on inclined plane 14 which becomes lower toward the outside, door body 1 can be opened by rotating knob 2 manually or by using auxiliary means. This can prevent a resident from being confined when a big earthquake occurs.

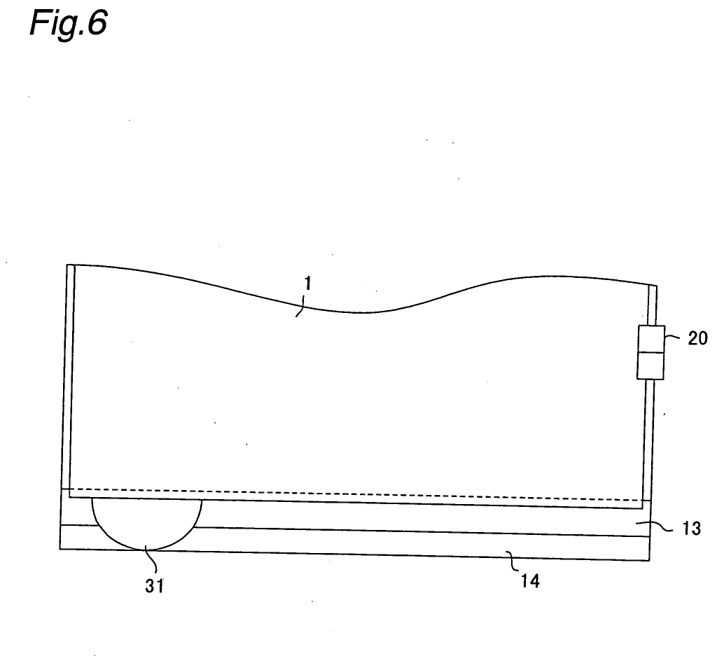

It is noted that if a ball caster 31 rotational in an arbitrary direction is used, as shown in FIGS. 5 and 6, in place of roller 30 as the rotary member mounted to lower wall 6 of door body 1, similar or more effect can be obtained. It is also noted that roller 30 and a ball caster 31 are mere examples and that any rotary member that can run on inclined plane 14 can be used.

It is easy to provide to a new building structure a door structure described above in reference with FIGS. 1 to 6. However, in order to convert an existing building structure to have a door structure according to the present invention, it is necessary that an inclined plane is provided to a door head and that an upper wall of an existing door body is altered to an inclined plane or that a door body is replaced with a door body having an inclined plane. Consequently, it is actually difficult to apply the present invention to an existing building structure in view of cost and construction work.

The present invention proposes a door altering member set capable of being easily applied to a door structure of an existing building structure for facilitating evacuation from a room when an earthquake occurs. The door altering member set includes a head mounted member and a door mounted member and, if required, a slope member. Hereafter, a door altering member set applicable to an existing door structure will be described.

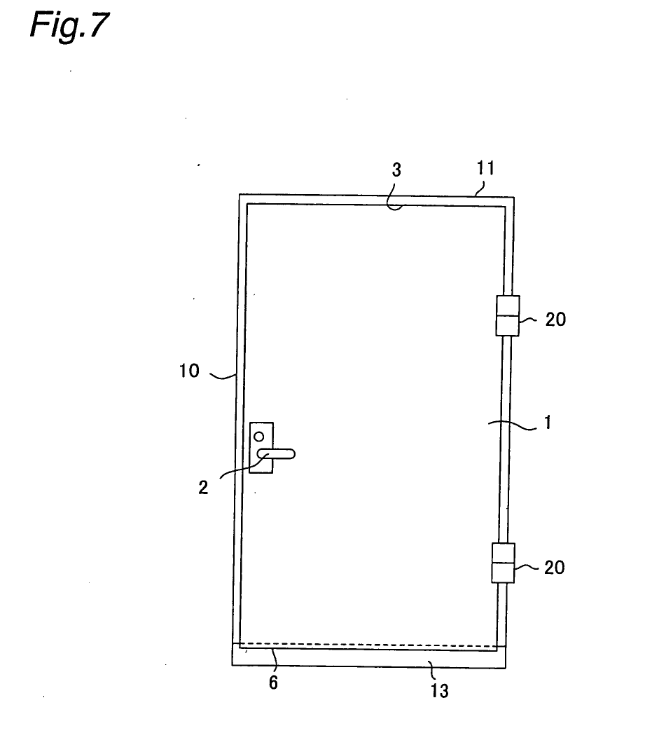

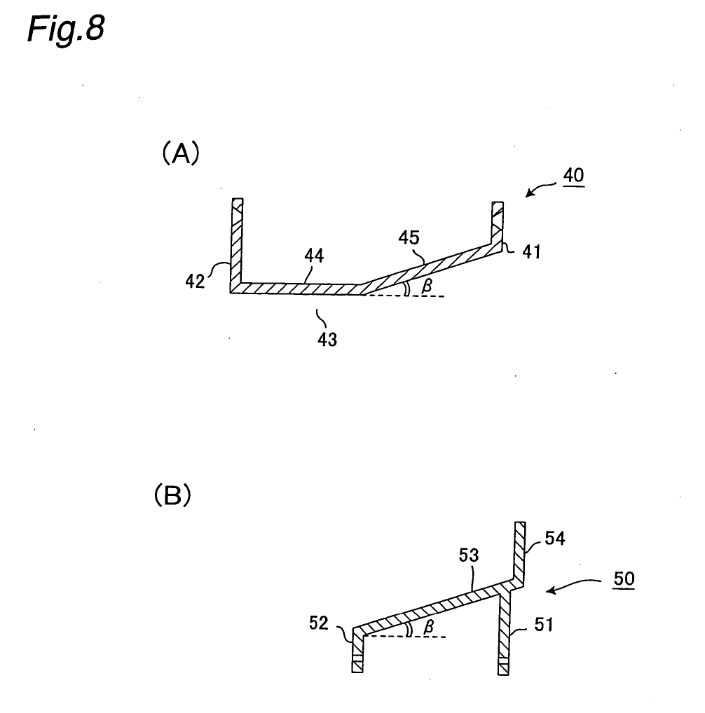

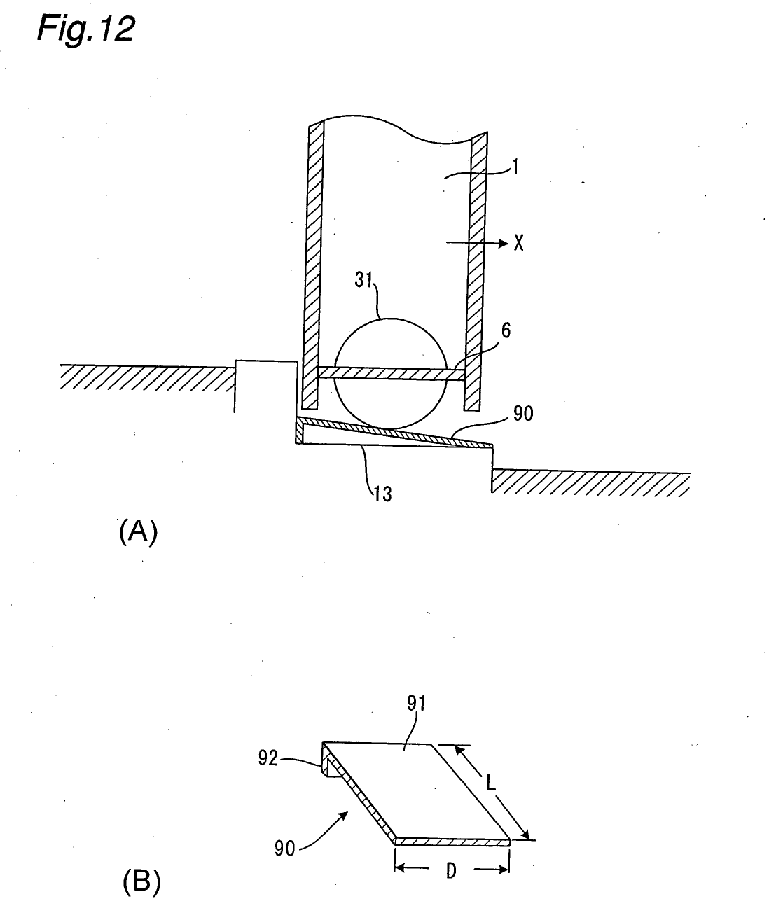

FIG. 7 is a front elevation view showing a common door structure provided to an existing building structure. It is noted that structural components similar to those shown in FIG. 1 are designated by the same reference numerals. In order to alter such an existing door structure to avoid a resident from being confined in a room in the event of an earthquake, a head mounted member 40 shown in FIG. 8(A) and a door mounted member 50 shown in FIG. 8(B) are provided. In addition to these members, it has been found that a slope member 90 shown in FIG. 12 is provided to open and close a door body quite easily.

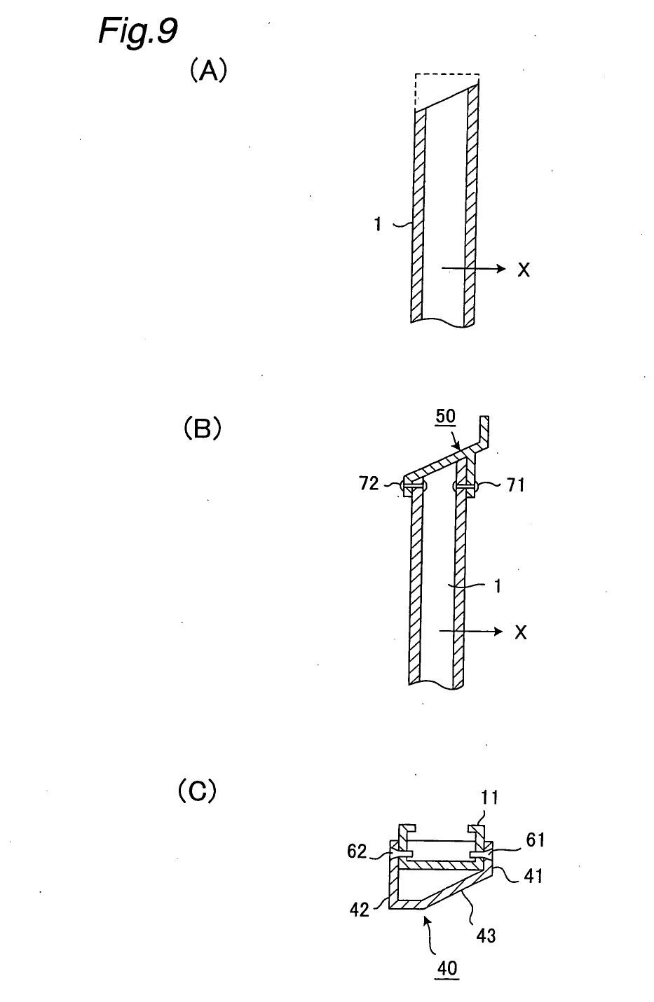

Head mounted member 40 shown in FIG. 8(A) comprises first and second mounting pieces 41 and 42 to be fixed to put door head 11 of existing door frame 10 therebetween. An intermediate piece 43 interconnects first and second mounting pieces 41 and 42. Intermediate piece 43 has a first flat plane 44 connected to second mounting piece 42 and a second plane 45 forming a predetermined angle β with respect to first mounting piece 44. First and second mounting pieces 41 and 42 of head mounted member 40 are, as shown in FIG. 9(C), fixed to door head 11 to put door head 11 between members 41 and 42 by means of screws 61 and 62. With this, second plane 45 that has an effect similar to inclined plane 12 shown in FIG. 2 is provided to door head 11.

Door mounted member 50 shown in FIG. 8(B) comprises, as shown in FIG. 9(B), first and second mounting pieces 51 and 52 that are fixed to front and back surfaces of door body 1 by an appropriate fixing means such as rivet to put an upper portion of door body 1 between members 51 and 52. First and second mounting pieces 51 and 52 are interconnected through an intermediate piece 53 forming a plane that is at an angle β to a horizontal direction. Consequently, if the upper portion of door body 1 is cut crosswise, as shown in FIG. 9(A), and door mounted member 50 is mounted to the upper portion of door body 1, as shown in FIG. 9(B), then, an inclined plane that corresponds to upper wall 3 shown in FIG. 2 is provided to the upper wall of door body 1.

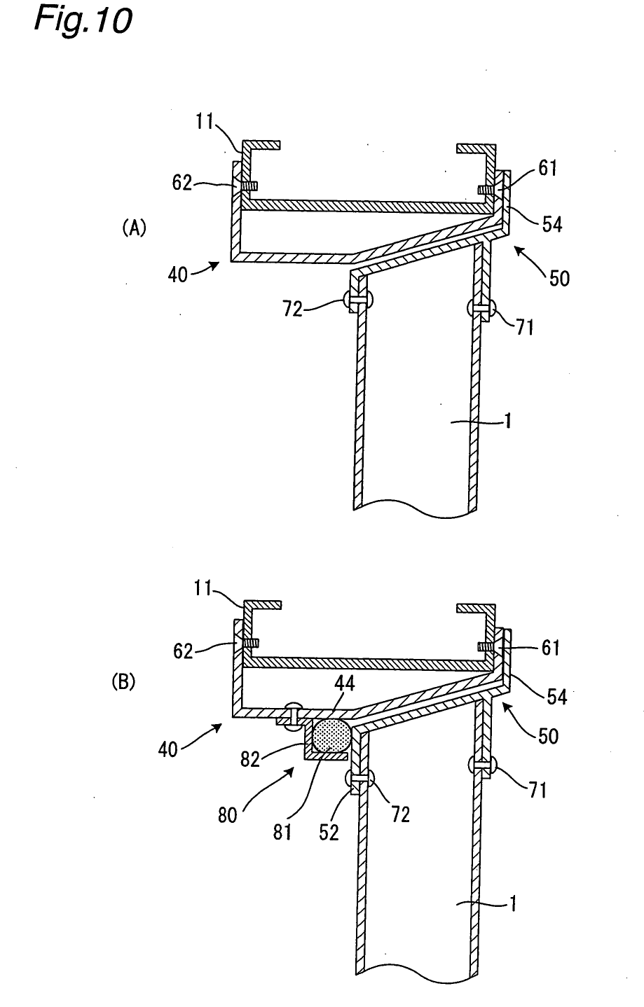

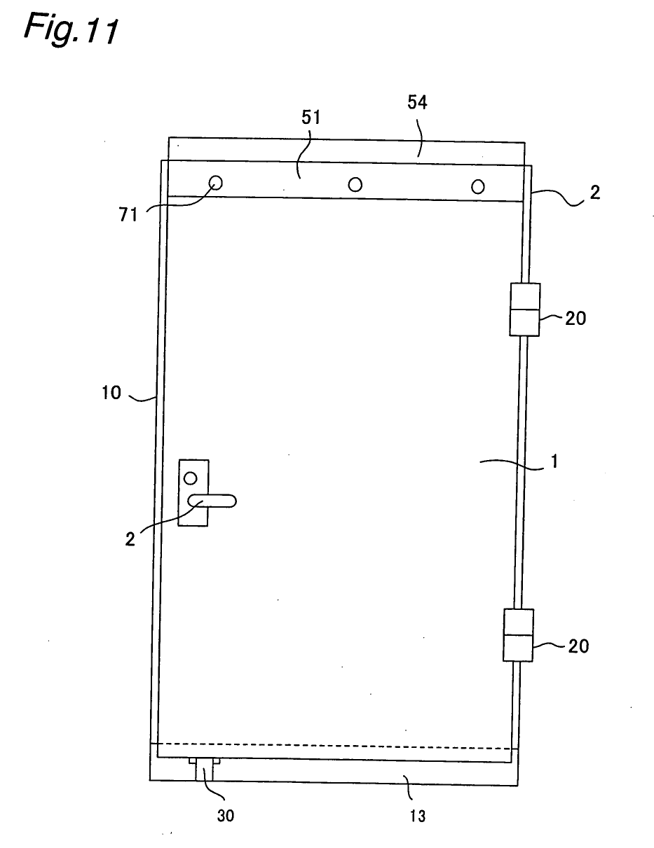

FIG. 10(A) shows a mutual positional relationship of members 40 and 50 when door body 1 is closed wherein head mounted member 40 is fixed to door head 11 by screws 61 and 62, and door mounted member 50 is fixed to door body 1 by rivets 71 and 72. Further, roller 30 or ball caster 31 is mounted to a lower portion of door body 1. With this structure, an existing door structure can be altered to a door structure capable of exhibiting advantages similar to the door structure explained with reference to FIGS. 1-6.

In order to crime prevention, it is preferable to provide a protruding piece 54 at one end of intermediate piece 53 of door mounted member 50 for hiding a gap between members 40 and 50 when door body 1 is closed.

As shown in FIG. 10(A), if head mounted member 40 is mounted to door head 11 and door mounted member 50 is mounted to the upper portion of door body 1, if even a slight gap is formed between those mounted members 40 and 50, there is a possibility that rain water and moisture can enter into a room even if protruding piece 54 is provided. In order to prevent this, it is preferable to use any sealing means. FIG. 10(B) shows an example of such sealing means. Sealing means 80 comprises a sealing elastic rubber 81 and a receiving member 82. Receiving member 82 is fixed to first plane 44 of intermediate piece 43 so that elastic rubber 81 is located between receiving member 82 and plane 44. With this structure, elastic rubber 81 is put among receiving member 82, mounting piece 52 and plane 44 so as to seal the gap between head mounted member 40 and door mounted member 50 when door body 1 is closed.

It is noted that any sealing means can be used in lieu of elastic rubber 81. Further, FIG. 10(B) shows receiving member 82 having a substantially L shape, but a member having any shape that can allocate such seal means as elastic rubber can be used.

In addition, some existing building structures have horizontal or nearly horizontal door sills 13. In such a case, in order to open and close door body 1 easily when an earthquake occurs, it is preferable to provide, between a horizontal door sill 13 and such a rotary member as roller 30 and ball caster 31, a slope member 90 having an inclined plane for guiding the rotary member in a direction to open door body 1, in addition to head mounted member 40 and door mounted member 50.

FIGS. 12(A) and 12(B) show an example of such slope member 90. Slope member 90 comprises a flat plane 91 having appropriate width D and length L and a leg 92 fixed to one end of flat plane 91. Because flat plane 91 can simply assist door body 1 to which a rotary member such as ball caster 31 is mounted to move in a door-opening direction, width D may be smaller than the width of door body 1. Further, it is preferable that length L of flat plane 91 is equal to or shorter than door sill 13. The length of leg 92 can be arbitrarily set so as to obtain a desired slant angle with respect to lower frame 13.

Embodiments of a door structure and a door altering member according to the present invention have been described in detail hereto, but the present invention is not limited to such embodiments. For example, the present invention is applicable to a door structure of a variety of building structures other than an entrance door structure of a high-rise apartment building, and, for example, applicable to a door structure of a room within a building structure. Further, a door structure according to the present invention is applicable to door bodies which open toward the inside as well as door bodies which open toward the outside.

It is noted that even when a door structure is locked and a door frame is distorted by an earthquake, the door body can be opened manually or by using auxiliary means because a force is exerted in a door-opening direction to the door body due to the distortion of the door frame.

1. A door structure having a door frame and a door body rotatably mounted to said door frame and capable of being installed to a building structure, comprising a mechanism for exerting a force to said door body in a door-opening direction due to a distortion of said door frame.

2. A door structure according to claim 1, wherein said door body comprises an inner surface, an outer surface, and an upper wall formed as an inclined flat plane that inclines linearly from the inner surface to the outer surface in the door-opening direction upward from a horizontal direction; wherein said door frame comprises a head and a sill, the head opposing to said upper wall of said door body; wherein said head has an inclined plane which is parallel to said upper wall when said door body is closed; and wherein said mechanism comprises said upper wall and said inclined plane.

3. A door structure according to claim 2, wherein said door body further comprises a rotary member which is mounted to an appropriate position to a lower wall opposing to said upper wall and which is in touch with said door sill.

4. A door structure according to claim 3, wherein said sill has a plane which inclines downward from a horizontal direction in the door-opening direction.

5. A door body having an inner surface, an outer surface and an upper wall and capable of being rotatably mounted to a door frame, said upper wall having a flat plane inclined linearly from said inner surface to said outer surface upward from a horizontal direction in a door-opening direction.

6. A door body according to claim 5, further comprising a rotary member mounted at an appropriate position to a lower wall opposing to said upper wall and which is in touch with a sill of said door frame.

7. A door frame to which a door body can rotatably be mounted, comprising a head and a sill, said head having an inclined plane inclining upward from a horizontal direction of said door body in a door-opening direction.

8. A head mounted member mounted to a head of a door frame to which a door body is rotatably mounted, comprising:
first and second mounting pieces fixed to said head; and
an intermediate piece interconnecting those mounting pieces, wherein said intermediate piece has a plane inclining upward from a horizontal direction in a door-opening direction when said intermediate piece is fixed to the head.

9. A door mounted member mounted to a door body capable of being rotatably mounted to a door frame, comprising:
first and second mounting pieces fixed to the door body; and
an intermediate piece interconnecting those mounting pieces, wherein said intermediate piece has a plane inclining upward from a horizontal direction in a door-opening direction when said intermediate piece is fixed to the door body.

10. A door structure altering member set comprising a head mounted member as claimed in claim 8 and a door mounted member comprising:
first and second mounting pieces fixed to the door body; and
an intermediate piece interconnecting those mounting pieces, wherein said intermediate piece has a plane inclining upward from a horizontal direction in a door-opening direction when said intermediate piece is fixed to the door body.

11. A door structure altering member set according to claim 10, further comprising a slope member placed on a sill of the door frame.

12. A method of altering a door structure including a door frame and a door body rotatably mounted to the door frame into a structure capable of exerting a force to the door body in a door-opening direction due to distortion of the door frame, said method comprising the steps of:
mounting a head mounted member as claimed in claim 8 to a head of the door frame;
fabricating an upper portion of the door body to form a plane inclining with respect to a horizontal direction; and
mounting a door mounted member to the upper portion of the door body, the door mounted member comprising:
first and second mounting pieces fixed to the door body; and
an intermediate piece interconnecting those mounting pieces, wherein said intermediate piece has a plane inclining upward from a horizontal direction in a door-opening direction when said intermediate piece is fixed to the door body.
